(19) United States
(12) Patent Application Publication
(10) Pub. No.: US 2019/0035190 A1
(43) Pub. Date: Jan. 31, 2019

(54) Smart Audiovideo Visitor/Vendor Entry System

(71) Applicant: JOHN SZCZYGIEL, BETHESDA, MD (US)

(72) Inventor: JOHN SZCZYGIEL, BETHESDA, MD (US)

(21) Appl. No.: 16/011,188

(22) Filed: Jun. 18, 2018

Related U.S. Application Data
(63) Continuation-in-part of application No. 15/202,519, filed on Jul. 5, 2016, now abandoned.
Application No. 15/202,519 is a continuation-in-part of application No. 15/054,028, filed on Feb. 25, 2016, now abandoned.

(51) Int. Cl. G07C 9/00

(52) U.S. Cl. CPC G07C 9/00309; G07C 2009/00769; G07C 9/00103

(57) ABSTRACT

A server is wirelessly coupled to mobile communication devices of residents of a community and to mobile communication devices of visitors. Each device provides geolocation indicia to the server for secure access control. A resident views the visitor, his badges, and the surroundings before enabling access through a portal to one or more of the areas. The visitor calls an alias phone number to request access, the server redirects the audio-visual connection to the mobile identity number of the resident which is not revealed to the visitor. The resident may enable access through a single portal or through a route specific to the role of the visitor when the resident is herself within the building or the campus. The request, authorization, and transit records are stored. An alert is triggered when the visitor fails to arrive at a destination or exit the premises within an allowable window of time.

### CROSS-REFERENCES TO RELATED APPLICATIONS

The present application is a continuation-in-part application of application Ser. No. 15/202,519 which is incorporated by reference and benefits from its filing date Jul. 5, 2016.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISK OR AS A TEXT FILE VIA THE OFFICE ELECTRONIC FILING SYSTEM (EFS-WEB)

Not Applicable

### STATEMENT REGARDING PRIOR DISCLOSURES BY THE INVENTOR OR A JOINT INVENTOR

Not Applicable

### BACKGROUND OF THE INVENTION

### Technical Field

Physical access control of delivery agents and visitors.

### Description of the Related Art

As is known, office tenants and apartment dwellers often have visitors or vendors who announce their arrival at the front or service entrance to a structure. A panel displays the unit numbers or name of the resident, who when contacted must actuate an electronic door lock/unlock apparatus.

As is known, malefactors may simply request access from every unit in a building in hopes that one of them will activate the entry door without verification or in expectation of a delivery. When the destination is other than the living unit, a resident may have to wait for the arrivals and escort them to a semi-public event space or service utility, e.g. bag check, mail, laundry, play area, patio, pool, ballroom, gym, electrical/communication, heating/cooling, food preparation/storage.

What is needed is a wireless system to enable residents of a community to unlock an entry for visitors without being tethered to a wall mounted panel within their living quarters.

What is needed is a wireless system to enable property owners/managers to enable scheduled or on demand delivery access through perimeter portals to storage facilities and enclosures by authenticated delivery agents.

### BRIEF SUMMARY OF THE INVENTION

A server is communicatively coupled to at least one gatekeeper apparatus, at least one portal actuator, and to at least one mobile visitor device. Responsive to the gatekeeper apparatus which may be a mobile device, the server synthesizes and revokes pairs of anti-tokens and tokens upon demand or by appointment. Anti-tokens are distributed to portals and tokens are transmitted to mobile visitor devices. When a portal matches an anti-token distributed from the server with a token presented by a mobile visitor, it actuates. Unmatchable tokens are stored at the portal and forwarded to the server which may reply with the matching anti-token or trigger an alert. Requests for access are received from the visitor device by the server and forwarded to the designated gatekeeper which may respond with a synthesis command or a denial. Tokens and anti-tokens include location and data-time validity indicia which must also match that of the portal. Tokens and anti-tokens selectably expire after a number of uses or persist through a date-time range which may be semi-infinite, scheduled by time of day, or day of week, etc. Gatekeeper apparatus, mobile visitor devices, and even portals may be location aware and their operation may depend on operating within boundaries within a campus, port, or electronic enclosure. Ports include harbors, airports, and transportation secured areas such as bridges and tunnels. Powered transport or mobility devices may be operable within regions of a shopping mall or factory or larger entity such as an aircraft carrier. Depending on policies, the gatekeeper may be remote or local to the protected property.

A resident of a gated or enclosed community may be anywhere in her apartment, house, on the campus, or remote. She may have visitors of various trust relationships ranging from family, service providers, delivery couriers, social guests, and health/home aides. A wireless system enables her to provide unscheduled or roaming access through a multi-level lock system without being bound to conventional wall-mounted intercom units.

The hostess may admit early, prompt, or late guests to a social/meeting room from her apartment, hallways, or the venue of the event after it has begun. She does not need to wait in the lobby to escort the visitor. The route of the visitor is limited to attend the gathering (and toilets). Route guidance may be provided from entry to destination, to emergency exits, and to nearest.

Service providers may be admitted to infrastructure areas of the building or campus for plumbing, instruction, training, storage, or cleaning.

A geolocation system may ensure that the gatekeeper is somewhere within certain buildings or campus and that the visitor is in the vicinity of each multi-level lock or portal.

The system enables scheduled access for deliveries. This can be accomplished via integration with a delivery service dispatch controller thus enabling a delivery agent access through perimeter portals to the property. A refrigerated space may be unlocked for perishable goods. License plate or QR code recognition causes remote means to trigger a door or trunk release.

Audio and visual transmission of the visitor and his identification enables a verification of both credential and proximity and record keeping of deliveries and visitors.

As is known, circuits as specified herein may be embodied in digital logic, programmable logic devices such as gate arrays and field programmable gate arrays, and computing devices such as microprocessors coupled to non-transitory stores of executable instructions.

### BRIEF DESCRIPTION OF THE SEVERAL VIEWS OF THE DRAWINGS

To further clarify the above and other advantages and features of the present invention, a more particular description of the invention will be rendered by reference to specific embodiments thereof that are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 is a system block diagram of a Smart Audiovideo Visitor/Vendor Entry System (SAVVES);

FIG. 2 is a method flow chart of processes for a Visitor mobile communication device;

FIG. 3 is a method flow chart of processes for a Resident mobile communication device;

FIG. 4 is a method flow chart of processes for a SAVVES access control server;

FIG. 5 is a method flow chart of processes for a portal actuator control device;

FIG. 6 is a block diagram of a processor suitable for performance of the computer executable methods of the invention.

FIG. 7 is a method flow chart of processes; and

FIG. 8 is a block diagram of a system exploiting the advantages of the invention.

### DETAILED DISCLOSURE OF EMBODIMENTS OF THE INVENTION

A system includes at least one electronically controlled portal actuator coupled to an access control server and a plurality of mobile communication devices.

In an embodiment, the server relays an access request to the mobile communication device of the party authorizing access. The access request may include video and audio or text and credential e.g. scanned badge or chip.

A server is wirelessly coupled to mobile communication devices of gatekeepers e.g. tenants and residents of a community and to mobile communication devices of visitors.

Each device provides geolocation indicia to the server for secure access control.

A gatekeeper views the visitor, his badges, and the surroundings before enabling access through a portal to one or more of the areas.

The visitor calls an alias phone number to request access, the server redirects the audio-visual connection to the mobile identity number of the resident which is not revealed to the visitor.

When the resident is herself within the building or the campus she enables access through a single portal or through a route specific to the role of the visitor. The server actuates at least one portal and enables the visitor through a sequence of portal e.g. elevators/stairways to the allowed destination.

The request, authorization, and transit records are stored.

An alert is triggered when the visitor fails to arrive at a destination or exit the premises within an allowable window of time.

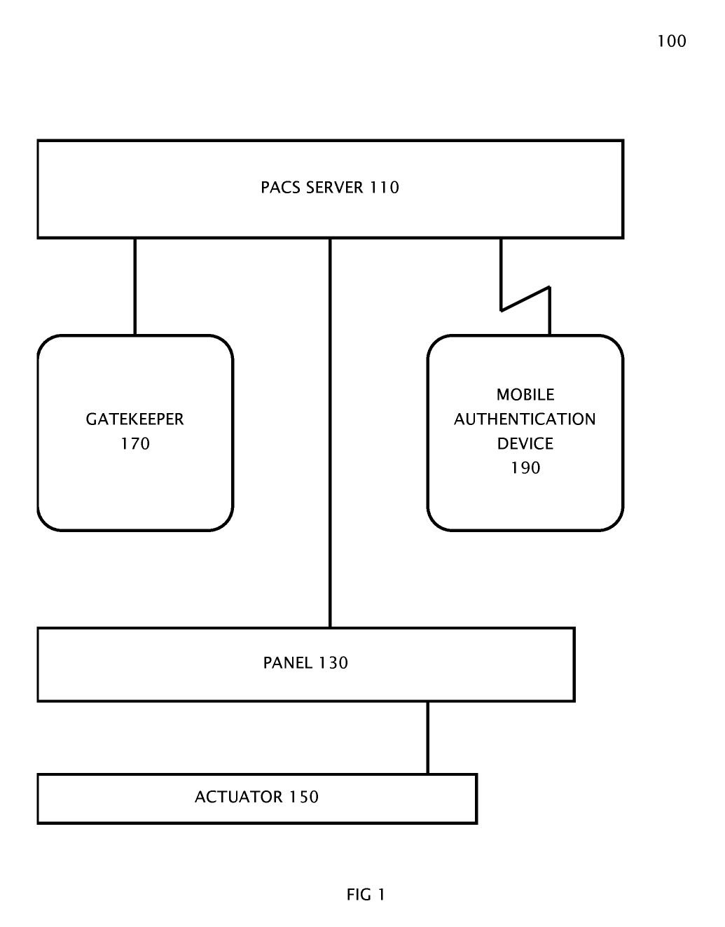

Referring now to the figures: FIG. 1 is a system block diagram 100 of a Smart Audiovideo Visitor Entry System (SAVES). A panel 130 is coupled to an actuator 150 and is further coupled to a PACS Server 110. The PACS Server is further coupled to at least one Gatekeeper 170 and to at least one Mobile Authentication Device 190.

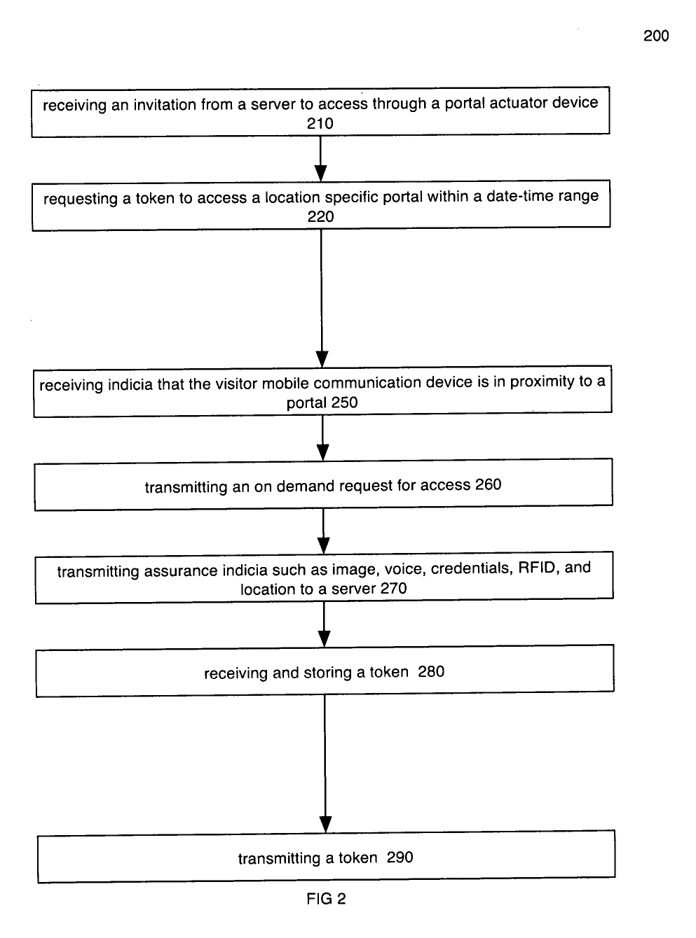

FIG. 2 is a method flow chart of processes 200 for a Visitor mobile communication device performing the following processes: receiving indicia that the visitor mobile communication device is in proximity to a portal 250; transmitting an on demand request for access 260; transmitting assurance indicia such as image, voice, credentials, RFID, and location to a server 270; receiving and storing a token 280; transmitting a token 290; receiving an invitation from a server to access through a portal actuator device 210; and requesting a token to access a location specific portal within a date-time range 220

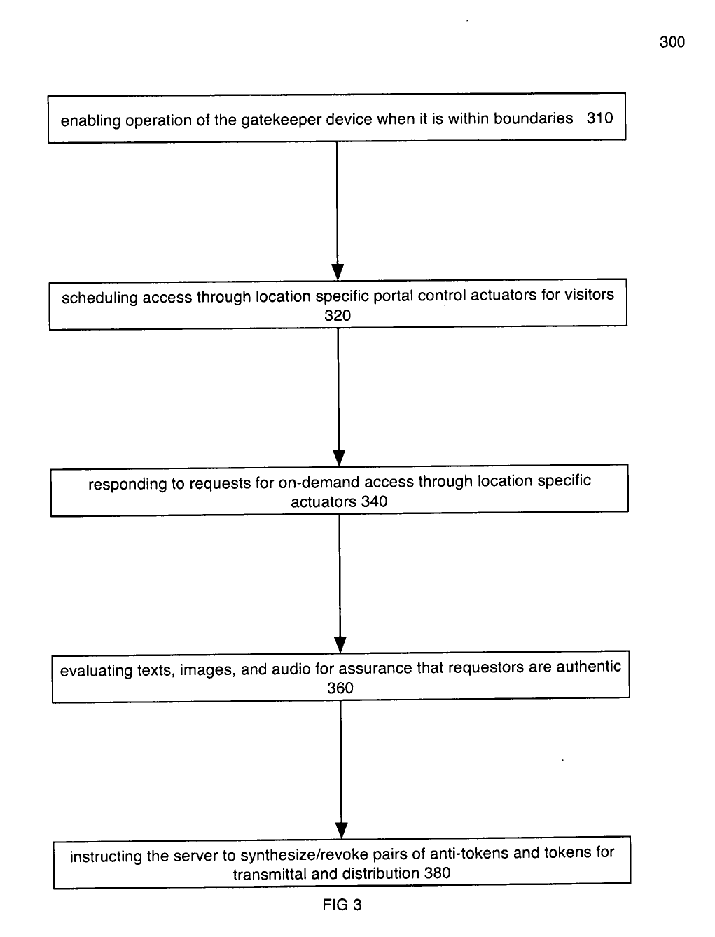

FIG. 3 is a method 300 flow chart of processes for a gatekeeper device performing the processes: scheduling access through location specific portal control actuators for visitors 320; responding to requests for on-demand access through location specific actuators 340; evaluating texts, images, and audio for assurance that requestors are authentic 360; instructing the server to synthesize/revoke pairs of anti-tokens and tokens for transmittal and distribution 380; and enabling operation of the gatekeeper device when it is within boundaries 310.

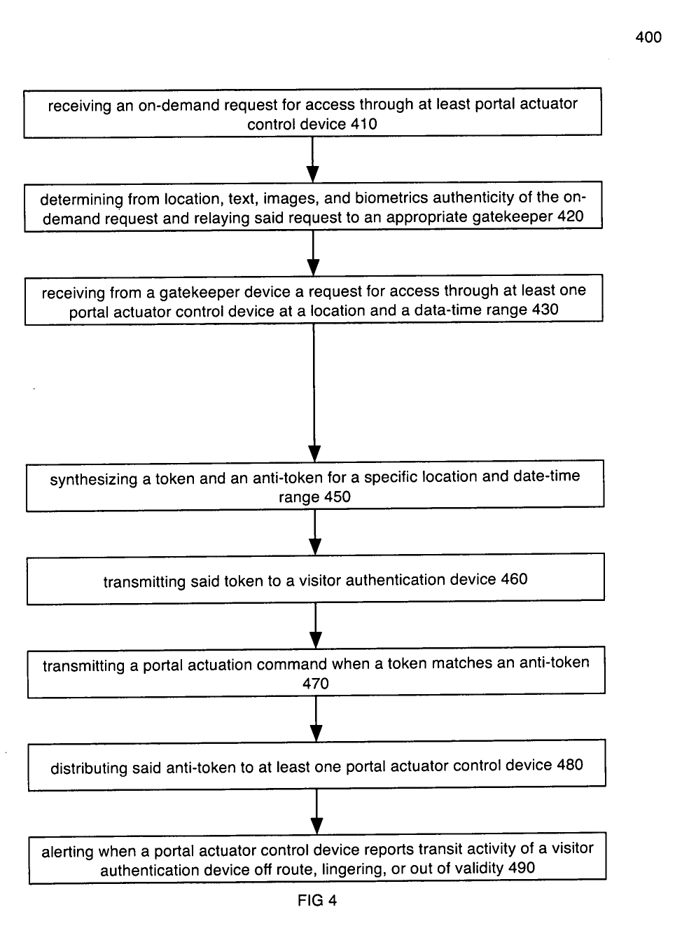

FIG. 4 is a method flow chart of processes 400 for an access control server performing the following processes: receiving from a gatekeeper device a request for access through at least one portal actuator control device at a location and a data-time range 430; synthesizing a token and an anti-token for a specific location and date-time range 450; transmitting said token to a visitor authentication device 460; distributing said anti-token to at least one portal actuator control device 480; receiving an on-demand request for access through at least portal actuator control device 410; determining from location, text, images, and biometrics authenticity of the on-demand request and relaying said request to an appropriate gatekeeper 420; transmitting a portal actuation command when a token matches an anti-token 470, and alerting when a portal actuator control device reports transit activity of a visitor authentication device off route, lingering, or out of validity 490.

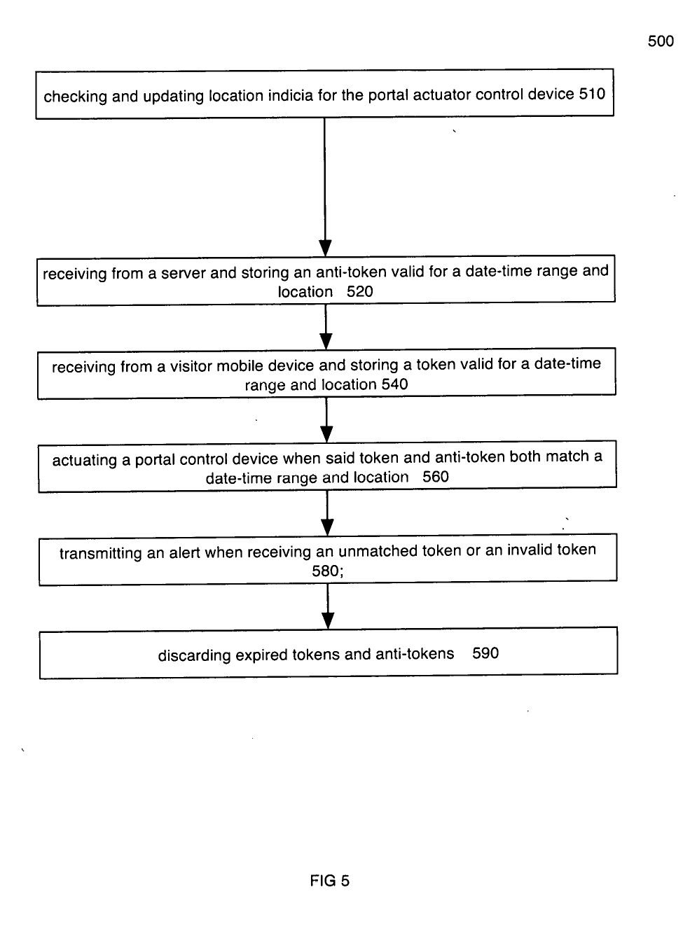

FIG. 5 is a method flow chart of processes 500 for a portal actuator control device having the processes: receiving from a server and storing an anti-token valid for a date-time range and location 520; receiving from a visitor mobile device and storing a token valid for a date-time range and location 540; actuating a portal control device when said token and anti-token both match a date-time range and location 560; transmitting an alert when receiving an unmatched token or an invalid token 580; discarding expired tokens and anti-tokens 590; and

in an embodiment, checking and updating location indicia for the portal actuator control device 510.

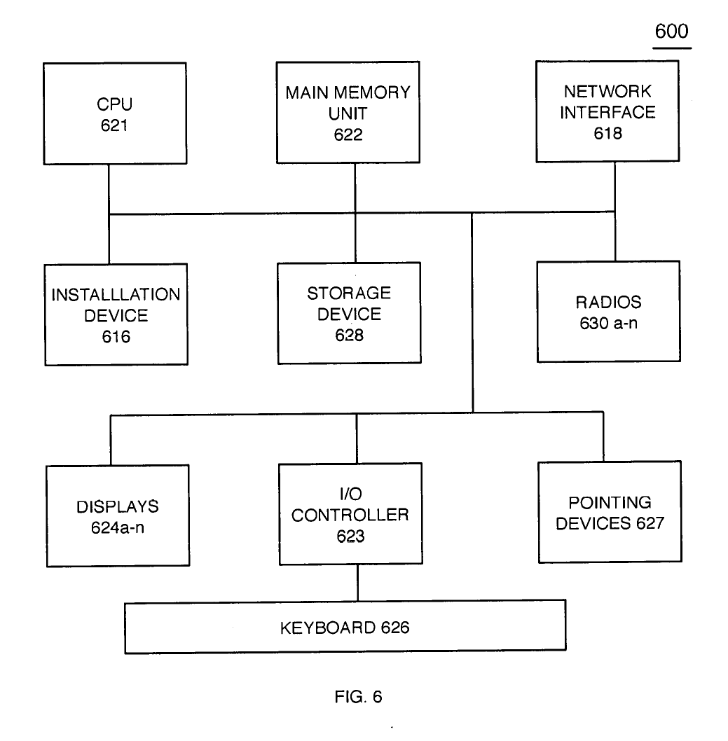

FIG. 6 is a block diagram of a processor suitable for performance of the computer executable methods of the invention.

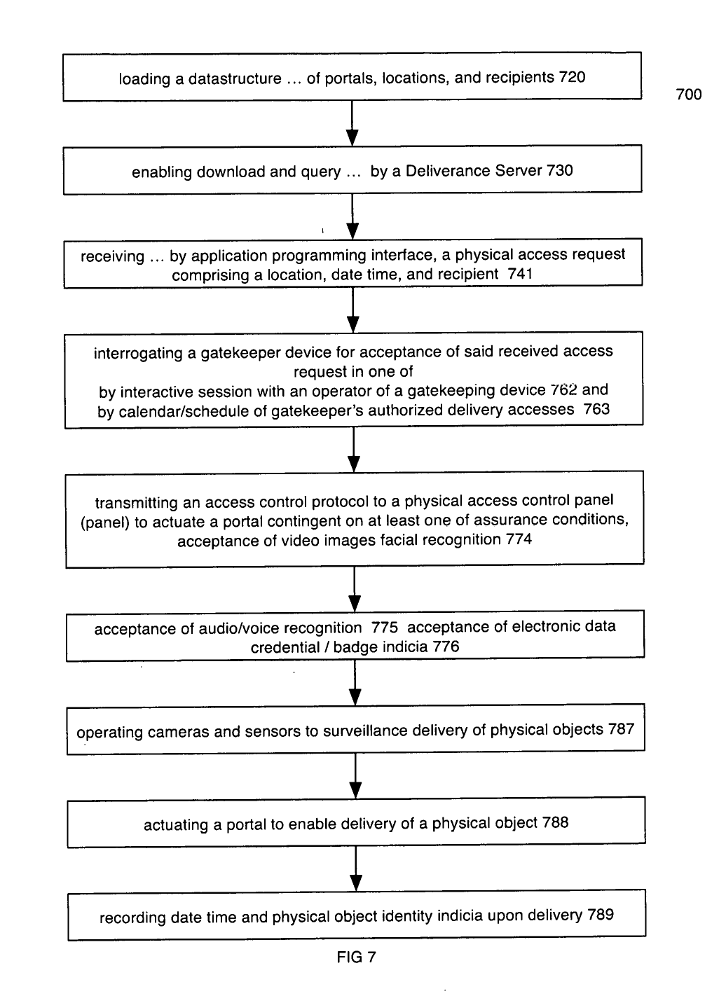

FIG. 7 is a flowchart for a method 700 for operation of physical access control system having the processes: receiving from a deliverance server by application programming interface, a physical access request comprising a location, date time, and recipient 741;

interrogating a gatekeeper device for acceptance of said received access request in one of by interactive session with an operator of a gatekeeping device 762, and by calendar/schedule of gatekeeper's authorized delivery accesses 763; transmitting an access control protocol to a physical access control panel (panel) to actuate a portal contingent on at least one of assurance conditions, acceptance of video images facial recognition 774, acceptance of audio/voice recognition 775 acceptance of electronic data credential/badge indicia 776; actuating a portal to enable delivery of a physical object 788; and recording date time and physical object identity indicia upon delivery 789.

Method 700 also includes loading a datastructure into non-transitory media of portals, locations, and recipients 720; enabling download and query on said datastructure by a Deliverance Server 730; and operating cameras and sensors to surveillance delivery of physical objects at a portal 787.

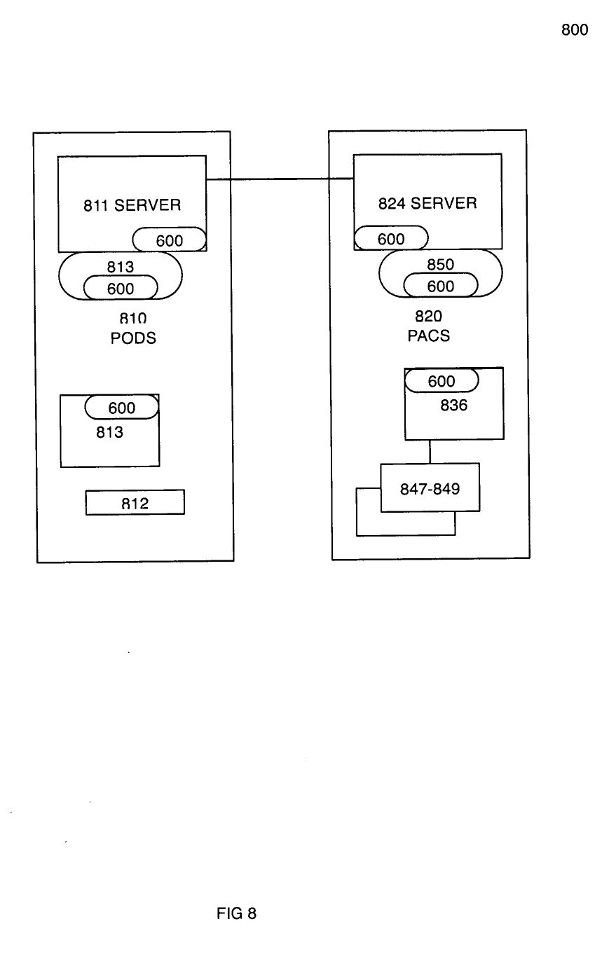

FIG. 8 is a block diagram of a system wherein said physical object deliverance system 810 (pods) comprises a pods server 811, non-transitory media 812, and at least one mobile delivery agent apparatus 813 wirelessly coupled to said pods server; wherein said physical access control system 820 (pacs) comprises a pacs server 824 coupled to at least one physical access control panel apparatus 836 (panel), the panel coupled to at least one physical access portal actuator 847-849 (actuator), and at least one wireless mobile gatekeeper device 850, all communicatively coupled together; wherein said physical object deliverance system 811 is communicatively coupled by an application programming interface (API) with the physical access control system server 824; wherein each device, apparatus, and server comprises at least one processor 600 and non-transitory computer readable media tangibly encoded with data and computer executable instructions.

Other aspects and embodiments of the invention are disclosed.

One aspect of the invention is a physical access control system (pacs) which comprises a pacs server; coupled to at least one physical access control panel apparatus (panel); the panel coupled to at least one physical access portal actuator (actuator); and at least one wireless mobile gatekeeper device, all mutually communicatively coupled.

In an embodiment, the system also includes: a physical object deliverance system (pods) which comprises: a pods server, non-transitory media, and at least one mobile delivery agent apparatus wirelessly coupled to said pods server; said physical object deliverance system coupled by an application programming interface to said physical access control system; and wherein each device, apparatus, and server comprises at least one processor and non-transitory computer readable media tangibly encoded with data and computer executable instructions.

Another aspect of the invention is a system to control multiple levels of access in a multi-lock residential community including: a server communicatively coupled to at least one gatekeeper and to at least one portal, at least one delivery agent dispatcher, and to at least one delivery agent authentication device; at least one electronic lock for access to semi-private, semi-public, and common shared zones which actuate when a token presented by a delivery agent authentication device matches location, and date-time indicia; and a network coupling all the above subsystem elements.

One aspect of the invention is a method for operation of a security augmented visitor entry system including: at a proprietor-controlled physical access control server, responsive to a gatekeeper apparatus, synthesizing a location-specific date-time valid access control token for portal actuator operation; transmitting said token to a mobile authentication device; receiving assurance, location, and date-time indicia from said mobile authentication device; and causing said portal actuator to enable access to the bearer of said mobile actuation device when assurance, location, and date-time indicia are acceptable to the gatekeeper.

In an embodiment, assurance indicia is at least one of text, audio, image, voice recognition, facial recognition, RFID, and a credential.

In an embodiment, the method also includes: synthesizing an anti-token which enables access when matching the location-specific date-time valid token; and distributing said anti-token to at least one location aware access control portal actuator.

In an embodiment, the method also includes: at a location-aware access control portal actuator, receiving an access control token from a mobile authentication device; determining the current location of the access control portal actuator; on the condition of determining a match of the location and date time range of the token and the current location and date time of the portal actuator, enabling access through the portal; and on the condition of failing said match, transmitting an alert to the server.

In an embodiment, the method also includes: at a mobile gatekeeper device, receiving, via the server, an authenticated mobile request to access at least one location specific portal during a date-time range; determining assurance by one of image, voice, text, credential, and RFID of the identity of bearer of said mobile authentication device; selecting a date-time range, persistence, and routing through location specific portals for access; and enabling generation and transmittal by the server of said token to the mobile authentication device.

In an embodiment, the method also includes: transmitting an invitation via the server to a mobile authentication device to access at least one location specific portal during a date-time range.

In an embodiment, the method also includes: at a mobile authentication device, transmitting a request to access at least one location specific portal during a date-time range with an authentication credential; receiving a token with date-time validity for at least one portal location; presenting said token when in proximity to each location specific portal; and discarding said token when expired.

In an embodiment, the method also includes: receiving an invitation to access a location specific portal.

In an embodiment, the method also includes: receiving from a fixed image capture and audio sensing device a verbal explanation and video of a visitor requesting access but not providing mobile device credentials; matching facial recognition indicia with a store of known residents or visitors; converting speech to text; transmitting text and images to a gatekeeper annotated in said store; receiving portal control instruction from said gatekeeper; and recording video, voice, and disposition of the request.

Another aspect of the invention is a security augmented visitor entry system including: a proprietor-controlled physical access control server communicatively coupled to: at least one location aware access control portal actuator; at least one mobile gatekeeper device; and at least one mobile visitor authentication device.

In an embodiment said proprietor-controlled physical access control server includes: a location and date-time access token generation circuit.

In an embodiment said location aware access control portal actuator includes: a non-transitory programmable store for its location indicia.

In an embodiment said mobile gate keeper device includes: a location sensing circuit.

In an embodiment said mobile visitor authentication device includes: a location sensing circuit.

In an embodiment, said proprietor-controlled physical access control server includes: transit routing, scheduling, and alerting circuits; and a non-transitory store of facial, voice, and biometric recognition indicia.

In an embodiment, said location aware access control portal actuator includes: a location sensing circuit coupled to a non-transitory programmable store for its location indicia.

In an embodiment, said said mobile gate keeper device includes: an RFID chip scanner.

In an embodiment, said mobile visitor authentication device includes: a forward facing camera, and a rear facing camera.

In an embodiment, the system also includes: a fixed location image capture and audio sensing device communicatively coupled to said server, whereby said server may determine facial recognition, voice recognition, speech to text, and dial-by-name for a visitor or gatekeeper in the absence of an operative mobile device.

Another aspect of the invention is method for operation of physical access control system comprising: receiving from a deliverance server by application programming interface, a physical access request comprising a location, date time, and recipient; interrogating a gatekeeper device for acceptance of said received access request in one of by interactive session with an operator of a gatekeeping device, and by calendar/schedule of gatekeeper's authorized delivery accesses; transmitting an access control protocol to a physical access control panel (panel) to actuate a portal contingent on at least one of assurance conditions, acceptance of video images facial recognition, acceptance of audio/voice recognition, and acceptance of electronic data credential/badge indicia; actuating a portal to enable delivery of a physical object; and recording datetime and physical object identity indicia upon delivery.

In an embodiment, the method also includes: loading a datastructure into non-transitory media of portals, locations, and recipients.

In an embodiment, the method also includes: enabling download and query on said datastructure by a Deliverance Server.

In an embodiment, the method also includes: operating cameras and sensors to surveille delivery of physical objects at a portal.

In an embodiment, the server is further coupled to a delivery service dispatcher and the mobile authentication device is provided by the delivery service to a delivery agent. In an embodiment, the token is transformed by the delivery service to be specific to the mobile authentication device assigned to the delivery agent for a fixed number of uses.

For this application, mobile authentication devices are embodied in the personal smart phone or visitors or in the mobile package tracking devices of delivery agents.

This solution addresses the unmet challenge that the identities and schedules of available drivers may change from day to day and their vehicles or equipment may be independently owned.

One aspect of the invention is a journey-based physical access control system for supply chain providers including a cloud access control server (server); the server coupled to, a hybrid communication network (network); the network coupled to, at least one location-sensitive mobile wireless device (devices); the devices coupled through the network to, at least one supply origination authentication anchor point (anchor point), wherein said network comprises wired and wireless communication channels. In an embodiment, it also includes a physical access controller which comprises a circuit to receive a command through the network from the server; and a circuit to cause a portal actuator to enable physical access at a supply destination (destination). In an embodiment, each device includes at least one location sensor and a store for locations sensed at the anchor point, between the anchor point and at least one destination, and in the vicinity of the destination. In an embodiment, the anchor point includes a trusted communication circuit to establish authentication and credentialization of the location-sensitive mobile wireless device at journey start.

Another aspect of the invention is a method for operating a location-sensitive mobile wireless device having the processes of connecting to an unattended physical access control server (server) at an anchor point; authenticating and installing a credential; receiving at least one location identifier in the vicinity of a destination; sensing and storing at least one location en route to the destination; sensing a location identifier in the vicinity of the destination; and transmitting to the server at least one location identifier using the credential installed at the anchor point.

Another aspect of the invention is a method for operating an unattended physical access control server by performing the following steps, connecting to a location-sensitive mobile wireless device at an anchor point; authenticating the device and installing a credential; receiving from the device at least one location identifier en route to a destination; receiving from the device a location identifier in the vicinity of the destination; and transmitting to a physical access controller at least one command to cause a portal actuator to enable physical access.

Another aspect of the invention is an unattended physical delivery access control system including a wireless mobile agent communicatively coupled to the following networked apparatus; an unattended destination portal; at least one location waypoint; at least one supplier origination apparatus; and a cloud-based physical access control server.

Another aspect of the invention is a method of operation for an unattended portal access system by performing at least the steps of establishing a credential between at least one supplier origination apparatus and a mobile device; transferring destination, journey routing, and transit tokens to said device; transacting a transit token with at least one location waypoint; and performing at least one unattended portal transaction.

It should be appreciated that the transformation of a raw video feed from a 3-D camera into an alert for a specific surveillance event that is presented on a display, or mobile communication device as limited in the attached claims may be implemented in hardware circuits or in programmable circuits which execute instructions stored in non-transitory media.

### CONCLUSION

Thus it can be appreciated that the invention is easily distinguished from conventional visitor entry systems by, elimination of a display directory of resident names, phone numbers, or unit numbers at a door improving their privacy; generation of location specific tokens for access at specific or persistent schedules; alerting when a visitor lingers at or transits a portal not en route to the intended destination; multiple levels of assurance for visitors; support for transporters assigned to ferry visitor/guests; and a failover system for visitors who have lost mobile connectivity.

Exemplary processors suitable for the performance of method embodiments to sense waypoints and control delivery destination portals are illustrated in FIG. 6.

FIG. 6 depicts block diagrams of a computing device 600 useful for practicing an embodiment of the invention. As shown in FIG. 6, each computing device 600 includes a central processing unit 621, and a main memory unit 622. A computing device 600 may include a storage device 628, an installation device 616, a network interface 618, an I/O controller 623, display devices 624a-n, a keyboard 626, a pointing device 627, such as a mouse or touchscreen, and one or more other I/O devices 630a-n such as baseband processors, Bluetooth, GPS, and Wi-Fi radios. The storage device 628 may include, without limitation, an operating system and software.

The central processing unit 621 is any logic circuitry that responds to and processes instructions fetched from the main memory unit 622. In many embodiments, the central processing unit 621 is provided by a microprocessor unit, such as: those manufactured under license from ARM; those manufactured under license from Qualcomm; those manufactured by Intel Corporation of Santa Clara, Calif.; those manufactured by International Business Machines of Armonk, N.Y.; or those manufactured by Advanced Micro Devices of Sunnyvale, Calif. The computing device 600 may be based on any of these processors, or any other processor capable of operating as described herein.

Main memory unit 622 may be one or more memory chips capable of storing data and allowing any storage location to be directly accessed by the microprocessor 621. The main memory 622 may be based on any available memory chips capable of operating as described herein.

Furthermore, the computing device 600 may include a network interface 618 to interface to a network through a variety of connections including, but not limited to, standard telephone lines, LAN or WAN links (e.g., 802.11, T1, T3, 56 kb, X.25, SNA, DECNET), broadband connections (e.g., ISDN, Frame Relay, ATM, Gigabit Ethernet, Ethernet-over-SONET), wireless connections, or some combination of any or all of the above. Connections can be established using a variety of communication protocols (e.g., TCP/IP, IPX, SPX, NetBIOS, Ethernet, ARCNET, SONET, SDH, Fiber Distributed Data Interface (FDDI), RS232, IEEE 802.11, IEEE 802.11a, IEEE 802.11b, IEEE 802.11g, IEEE 802.11n, CDMA, GSM, WiMax and direct asynchronous connections). In one embodiment, the computing device 600 communicates with other computing devices 600 via any type and/or form of gateway or tunneling protocol such as Secure Socket Layer (SSL) or Transport Layer Security (TLS). The network interface 118 may comprise a built-in network adapter, network interface card, PCMCIA network card, card bus network adapter, wireless network adapter, USB network adapter, modem or any other device suitable for interfacing the computing device 600 to any type of network capable of communication and performing the operations described herein.

A computing device 600 of the sort depicted in FIG. 6 typically operates under the control of operating systems, which control scheduling of tasks and access to system resources. The computing device 600 can be running any operating system such as any of the versions of the MICROSOFT WINDOWS operating systems, the different releases of the Unix and Linux operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: WINDOWS 10 and WINDOWS VISTA, manufactured by Microsoft Corporation of Redmond, Wash.; MAC OS and iOS, manufactured by Apple Inc., of Cupertino, Calif.; or any type and/or form of a Unix operating system.

In some embodiments, the computing device 600 may have different processors, operating systems, and input devices consistent with the device. In other embodiments the computing device 600 is a mobile device, such as a JAVA-enabled cellular telephone or personal digital assistant (PDA). The computing device 600 may be a mobile device such as those manufactured, by way of example and without limitation, Kyocera of Kyoto, Japan; Samsung Electronics Co., Ltd., of Seoul, Korea; Nokia of Finland; Hewlett-Packard Development Company, L.P. and/or; Sony Ericsson Mobile Communications AB of Lund, Sweden; or Research In Motion Limited, of Waterloo, Ontario, Canada. In yet other embodiments, the computing device 600 is a smart phone, Pocket PC Phone, or other portable mobile device supporting Microsoft Windows Mobile Software.

In some embodiments, the computing device 600 comprises a combination of devices, such as a mobile phone combined with a digital audio player or portable media player. In another of these embodiments, the computing device 600 is device in the iPhone smartphone line of devices, manufactured by Apple Inc., of Cupertino, Calif. In still another of these embodiments, the computing device 600 is a device executing the Android open source mobile phone platform distributed by the Open Handset Alliance; for example, the device 600 may be a device such as those provided by Samsung Electronics of Seoul, Korea, or HTC Headquarters of Taiwan, R.O.C. In other embodiments, the computing device 600 is a tablet device such as, for example and without limitation, the iPad line of devices, manufactured by Apple Inc.; the Galaxy line of devices, manufactured by Samsung; and the Kindle manufactured by Amazon, Inc. of Seattle, Wash.

The techniques described herein can be implemented in digital electronic circuitry, or in computer hardware, firmware, software, or in combinations of them. The techniques can be implemented as a wireless device, i.e., firmware tangibly embodied in a non-transitory medium, e.g., in a machine-readable storage device, for execution by, or to control the operation of circuit apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and connected by a wireless network.

Method steps of the techniques described herein can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application-specific integrated circuit). Modules can refer to portions of the computer program and/or the processor/special circuitry that implements that functionality.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices. The processor and the memory can be supplemented by, or incorporated in special purpose logic circuitry.

A number of embodiments of the invention have been described. Nevertheless, it will be understood that various modifications may be made without departing from the spirit and scope of the invention. For example, other network topologies may be used. Accordingly, other embodiments are within the scope of the following claims.

We claim:

1. A physical access control system (pacs) which comprises a pacs server; coupled to
at least one physical access control panel apparatus (panel); the panel coupled to
at least one physical access portal actuator (actuator); and
at least one wireless mobile gatekeeper device, all mutually communicatively coupled.

2. The system of claim 1 further comprising:
a physical object deliverance system (pods) which comprises:
a pods server,
non-transitory media, and
at least one mobile delivery agent apparatus wirelessly coupled to said pods server; said physical object deliverance system coupled by an application programming interface to
said physical access control system; and
wherein each device, apparatus, and server comprises at least one processor and non-transitory computer readable media tangibly encoded with data and computer executable instructions.

3. A system to control multiple levels of access in a multi-lock residential community comprising:
a server communicatively coupled to at least one gatekeeper and to at least one portal, at least one delivery agent dispatcher, and to at least one delivery agent authentication device;
at least one electronic lock for access to semi-private, semi-public, and common shared zones which actuate when a token presented by a delivery agent authentication device matches location, and date-time indicia; and
a network coupling all the above subsystem elements.

4. A method for operation of a security augmented visitor entry system comprising:
at a proprietor-controlled physical access control server, responsive to a gatekeeper apparatus,
synthesizing a location-specific date-time valid access control token for portal actuator operation;
transmitting said token to a mobile authentication device;
receiving assurance, location, and date-time indicia from said mobile authentication device; and
causing said portal actuator to enable access to the bearer of said mobile actuation device when assurance, location, and date-time indicia are acceptable to the gatekeeper.

5. The method of claim 4 wherein assurance indicia is at least one of text, audio, image, voice recognition, facial recognition, RFID, and a credential.

6. The method of claim 4 further comprising:
synthesizing an anti-token which enables access when matching the location-specific date-time valid token; and
distributing said anti-token to at least one location aware access control portal actuator.

7. The method of claim 4 further comprising:
at a location-aware access control portal actuator,
receiving an access control token from a mobile authentication device;
determining the current location of the access control portal actuator;
on the condition of determining a match of the location and date time range of the token and the current location and date time of the portal actuator, enabling access through the portal; and
on the condition of failing said match, transmitting an alert to the server.

8. The method of claim 4 further comprising:
at a mobile gatekeeper device,
receiving, via the server, an authenticated mobile request to access at least one location specific portal during a date-time range;
determining assurance by one of image, voice, text, credential, and RFID of the identity of bearer of said mobile authentication device;
selecting a date-time range, persistence, and routing through location specific portals for access; and
enabling generation and transmittal by the server of said token to the mobile authentication device.

9. The method of claim 8 further comprising:
transmitting an invitation via the server to a mobile authentication device to access at least one location specific portal during a date-time range.

10. The method of claim 4 further comprising:
at a mobile authentication device,
transmitting a request to access at least one location specific portal during a date-time range with an authentication credential;
receiving a token with date-time validity for at least one portal location;
presenting said token when in proximity to each location specific portal; and
discarding said token when expired.

11. The method of claim 10 further comprising:
receiving an invitation to access a location specific portal.

12. The method of claim 4 further comprising:
receiving from a fixed image capture and audio sensing device a verbal explanation and video of a visitor requesting access but not providing mobile device credentials;
matching facial recognition indicia with a store of known residents or visitors;
converting speech to text;
transmitting text and images to a gatekeeper annotated in said store;
receiving portal control instruction from said gatekeeper; and
recording video, voice, and disposition of the request.

13. A security augmented visitor entry system comprising:
a proprietor-controlled physical access control server communicatively coupled to:
at least one location aware access control portal actuator;
at least one mobile gatekeeper device; and
at least one mobile visitor authentication device.

14. The system of claim 13 wherein said proprietor-controlled physical access control server comprises:
a location and date-time access token generation circuit.

15. The system of claim 13 wherein said location aware access control portal actuator comprises:
a non-transitory programmable store for its location indicia.

16. The system of claim 13 wherein said mobile gate keeper device comprises:
a location sensing circuit.

17. The system of claim 13 wherein said mobile visitor authentication device comprises:
a location sensing circuit.

18. The system of claim 13 wherein said proprietor-controlled physical access control server comprises:
transit routing, scheduling, and alerting circuits; and
a non-transitory store of facial, voice, and biometric recognition indicia.

19. The system of claim 13 wherein said location aware access control portal actuator comprises:
a location sensing circuit coupled to a non-transitory programmable store for its location indicia.

20. The system of claim 13 wherein said mobile gate keeper device comprises:
an RFID chip scanner.

21. The system of claim 13 wherein said mobile visitor authentication device comprises:
a forward facing camera, and
a rear facing camera.

22. The system of claim 13 further comprising:
a fixed location image capture and audio sensing device communicatively coupled to said server, whereby said server may determine facial recognition, voice recognition, speech to text, and dial-by-name for a visitor or gatekeeper in the absence of an operative mobile device.

23. A method for operation of physical access control system comprising:
receiving from a deliverance server by application programming interface, a physical access request comprising a location, date time, and recipient;
interrogating a gatekeeper device for acceptance of said received access request in one of by interactive session with an operator of a gatekeeping device, and by calendar/schedule of gatekeeper's authorized delivery accesses;
transmitting an access control protocol to a physical access control panel (panel) to actuate a portal contingent on at least one of assurance conditions, acceptance of video images facial recognition, acceptance of audio/voice recognition, and acceptance of electronic data credential/badge indicia;
actuating a portal to enable delivery of a physical object; and
recording datetime and physical object identity indicia upon delivery.

24. The method of claim 23 further comprising:
loading a datastructure into non-transitory media of portals, locations, and recipients.

25. The method of claim 23 further comprising:
enabling download and query on said datastructure by a Deliverance Server.

26. The method of claim 23 further comprising:
operating cameras and sensors to surveille delivery of physical objects at a portal.
